(19) United States
(12) Patent Application Publication
(10) Pub. No.: US 2005/0208249 A1
(43) Pub. Date: Sep. 22, 2005

(54) Curable elastomeric adhesive compositions

(75) Inventors: Weijian Wen, Novi, MI (US); Shahid Ghazi, Farmington Hills, MI (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: Sika Automotive, Madison Heights, MI (US)

(21) Appl. No.: 10/804,378

(22) Filed: Mar. 19, 2004

(51) Int. Cl. B32B 9/00

(52) U.S. Cl. 428/40.1; 428/355 EN

(57) ABSTRACT

The present invention relates to adhesive compositions for use in the building and construction industry. In some embodiments, the invention is an adhesive composition comprised of a halogenated copolymer of isobutylene and paramethylstyrene, tackifier, one or more fillers, and an amine curative agent. Optionally, embodiments may also comprise an antioxidant. In other embodiments, the invention is an adhesive tape comprised of a layer of a cured adhesive composition in the form of a strip on a release liner, said adhesive composition comprising comprised of a halogenated copolymer of isobutylene and paramethylstyrene, tackifier, one or more fillers, and an amine curative agent, and optionally, an antioxidant.

### FIELD OF THE INVENTION

The present invention relates to adhesive compositions for use in the building and construction industry.

### BACKGROUND OF THE INVENTION

Butyl rubber-based adhesive compositions are known in the building and construction industry. Such adhesive compositions are often formulated with non-crosslinked copolymers of polyisobutylene and isoprene that exhibit cold flow characteristics under certain conditions, for example, under a constant load or gravitational influences over a long duration. Further, upon exposure to extremes of light or temperature, such conditions may lead to chain scission, loss of elasticity, or other characteristics that make the use of adhesive compositions based on non-crosslinked butyl rubbers unsuitable or uneconomical for many applications. In some instances, although addition of some pre-crosslinked butyl rubber components may used to overcome these undesirable characteristics, dispersion of those components during manufacture, as well as the cost of such materials, remain as obstacles to their widespread or economical use in many applications.

These considerations are particularly important in certain markets in the building and construction industry. As one example only, and without limitation, there remains a need for suitable and economical adhesives for use in remodeling projects, such the re-fitting of bathroom fixtures, tubs, and walls with replacement bath linings, including among them, acrylic bathliners and shower walls.

The present invention addresses this need by providing, among its embodiments, a curable elastomeric adhesive composition which provides increased strength while allowing a reduction in rubber content and corresponding production cost.

### SUMMARY OF THE INVENTION

The present invention comprises an adhesive composition based on the chemical curing of halogenated isobutylene/para-methylstyrene copolymer. Amine-containing compounds are used as curatives to provide controlled curing. The backbone of the halogenated para-methylstryene-isobutylene copolymer of the invention contains no unsaturation. Accordingly, among its embodiments, without limitation, the present invention provides a cured elastomeric adhesive composition with increased ultraviolet light and heat resistance, along with good high temperature performance and good durability.

In some embodiments, the invention is an adhesive composition comprised of a halogenated copolymer of isobutylene and paramethylstyrene, tackifier, one or more fillers, and an amine curative agent. Optionally, the embodiment also comprises an antioxidant. In other embodiments, the invention is an adhesive tape comprised of a layer of a cured adhesive composition in the form of a strip on a release liner, said adhesive composition comprised of a halogenated copolymer of isobutylene and paramethylstyrene, tackifier, one or more fillers, and an amine curative agent, and optionally, an antioxidant.

Other aspects and embodiments of the invention will be apparent to those skilled in the art after reviewing the detailed description below.

### DETAILED DESCRIPTION

The present invention is comprised of a curable elastomeric adhesive composition that includes a halogenated copolymer of isobutylene and paramethylstyrene, tackifier, one or more fillers, and an amine curative agent, and optionally, an antioxidant. In some embodiments, the cured adhesive composition comprising the present invention is in the form of a strip on a release liner.

The present invention may be comprised of any halogenated copolymer component that provides rubber content suitable for crosslinking under appropriate conditions. Acceptable halogenated copolymers include, without limitation, brominated copolymers of isobutylene and paramethylstyrene available under the trade names Exxpro 3035, Exxpro 3433, and Exxpro 3745 (Exxon Chemical), with Exxpro 3433 being most preferred.

The cured adhesive composition also includes at least one tackifier or plasticizer. Suitable tackifiers or plasticizers will be known to those of ordinary skill in the art and are available commercially, for example, as Indopol H100 or Indopol H1500 (BP Amoco Chemical Co.), Piccopale 100 (Hercules Inc.), or Escorez 2101 (ExxonMobil Chemical).

The invention is also comprised of one or more fillers. Such fillers may comprise, without limitation, common fillers, as some examples only, calcium carbonate (for example, Quincy 325 available from Quincy Carbonates), barium sulfate, and clay, and reinforcing fillers, such as talc (for example, Magsil 399 from Whittaker Clark Daniels), precipitated silica (for example, Ultrasil VN3SP available for Degussa Corporation), and carbon black.

An amine-containing curative agent is used to promote cross-linking of the halogenated copolymer component and thereby enhance desired strength and performance characteristics. Acceptable amine curative agents include, without limitation, triethylenetetraamine (e.g., “TETA”, from Dow Chemical Company), hexamethyleneamine (e.g., “HEXA,” from Wright Chemicals), 2-methylpentamethylenediamine (e.g., “Dytek A” from Dupont), and 1, 3-pentanediamine (e.g., “Dytek EP” from Dupont). The content of the curative agent and/or the halogenated copolymer component may be varied to adjust the desired cure rate of the adhesive composition.

The invention may also comprise an antioxidant as a processing stabilizer. Suitable antioxidants include, without limitation, Wingstay L available from Goodyear Chemical. In some embodiments, without limitation, other processing aids known to those of ordinary skill, such as paraffinic oil, may be used.

For end uses in environments with an increased possibility of microbial growth, the invention may comprise a suitable antimicrobial additive or biocide known to those of ordinary skill, as one example only, diiodomethyl-p-tolysulfone, available under the trade name Amical 48.

Without limitation, Table 1 describes, in weight percent, formulations of certain embodiments in accordance with the invention:

TABLE 1

| Sub-Component | Suitable | Preferred |
|---|---|---|
| Exxpro 3433 | 1-15% | 4-8% |
| Antioxidant | 0.01-1% | 0.05-0.5% |
| Biocide | 0.01-1% | 0.01-0.2% |
| Tackifiers/plasticizers | 10-30% | 15-25% |
| Fillers | 50-90% | 60-80% |
| Reinforcing Fillers | 0.5-10% | 1-5% |
| Amine Curing Agent | 0.001-1% | 0.01-0.1% |

The following is exemplary of the general process for producing embodiments of the claimed invention. Times and temperatures can vary depending on the batch size and the mixer used.

Mixing is done in a sigma blade mixer. First the halogenated copolymer component is masticated in the oil-heated mixer for about five minutes. Next, precipitated silica (Ultrasil VN3SP), antioxidant (Wingstay L), one-third of the filler component (calcium carbonate) and one-third of the tackifier component (polybutene) are added and mixed for about thirty-five minutes or until the mixture is generally homogeneous in appearance and without substantial rubber lumps. The remaining filler and tackifier components are added in two steps and mixed for five minutes in each step. When the mixture is a smooth paste, the curative is added, and the mixture is monitored for changes in consistency. The mixture is then placed in tubs for extrusion.

A rubber extruder is used, and extrusion takes place according to methods known to those of ordinary skill. Barrel and die temperature are kept at around 180° F. A positive feed of the extruder should be maintained to prevent air entrapment. The extrudate should be cooled as quickly as possible for good roll winding. The mastic obtained from the mixing process is then extruded into tapes of optional dimensions according to the targeted end use. Release paper used in accordance with the invention may comprise siliconized papers comprising with various dimensions.

### EXAMPLES

Exemplary compositions comprising the invention were prepared and tested for physical properties as indicated in Table 2, 3 and 4 below. Peel strength measurements were conducted on an Imass SP-2000 peel tester. Samples of 2-mm thickness with masking tape backing were tested. Samples were pressed on a 4.5 pounds roller and dwelled for 1 hour before testing. A peel speed of 12 inches/minute was used. Cone penetration was measured on a Kohler penetrometer per ASTM D217 with following modification. Tape samples of the dimension 2″×1″×1″ were conditioned in a 77° F. water bath for 1 hour before testing. Tensile adhesive strength was measured per ASTM C907 using aluminum discs on a MTS tensile machine. AAMA sag tests were conducted at 180° F. for 14 days in an air-circulating oven per AAMA 804.3-92 specifications.

TABLE 2

| | Examples | | | |
|---|---|---|---|---|
| | 1 | 2 | 3 | 4 |
| Sub-components | % by weight | | | |
| Exxpro 3433 | 4.60 | 6.50 | 5.01 | 6.50 |
| Antioxidant | 0.13 | 0.13 | 0.13 | 0.13 |
| Piccopal 100 | 2.15 | 2.15 | — | — |
| Escorez 2394 | — | — | — | 3.00 |
| Amical 48 | — | — | 0.04 | — |
| Polybutene | 13.05 | 12.38 | 21.18 | 13.20 |
| Oil | 6.14 | 5.90 | — | 4.50 |
| Calcium carbonate | 68.31 | 67.34 | 71.53 | 67.56 |
| Talc | 3.84 | 3.84 | 0.00 | 3.65 |
| Precipitated silica | 1.69 | 1.69 | 2.07 | 1.40 |
| Amine curative | 0.09 | 0.07 | 0.04 | 0.07 |
| Specific Gravity | 1.79 | 1.77 | 1.73 | 1.76 |
| (ASTM D792) | | | | |
| Initial cone penetration | 105 | 87 | 105 | 75 |
| (ASTM D217) | | | | |
| 90° Peel Strength | 6.1 | 6.1 | 6.7 | 6.8 |
| @77° F., pli (ASTM | CF* | CF | CF | CF |
| D903-98 modified) | | | | |
| Tensile Strength | 20 | 20 | 25 | 30 |
| @77° F., psi | CF | CF | CF | CF |
| (ASTM C907) | | | | |
| Sag (AAMA 807.3-92) | Pass | Pass | Pass | Pass |
| Vehicle Bleedout | Pass | Pass | Pass | Pass |
| (ASTM C772) | | | | |
| Resistance to fungus/ | Excellent | Excellent | Excellent | Excellent |
| mildew grow | | | | |
| Flexibility (ASTM C765) | Good | Good | Good | Good |

*CF = Cohesive failure

TABLE 3

| Examples | | | | |
|---|---|---|---|---|
| 5 | 6 | 7 | 8 | 9 |

% by weight

Sub-components

| | | | | | |
|---|---|---|---|---|---|
| Exxpro 3433 | 5.00 | 5.00 | 5.00 | 5.00 | 5.00 |
| Antioxidant | 0.13 | 0.13 | 0.13 | 0.13 | 0.13 |
| Biocide | 0.04 | 0.04 | 0.03 | 0.03 | 0.03 |
| Polybutene | 21.15 | 21.19 | 20.72 | 20.72 | 20.72 |
| Calcium carbonate | 67.12 | 71.56 | 69.10 | 69.10 | 74.10 |
| Talc | 3.50 | — | 5.00 | 5.00 | — |
| Precipitated silica | 3.05 | 2.07 | — | — | — |
| Amine curative | 0.01 | 0.01 | 0.01 | 0.02 | 0.03 |
| Specific gravity | 1.74 | 1.76 | 1.76 | 1.76 | 1.77 |
| Initial cone | 103 | 103 | 94 | 93 | 110 |
| penetration | | | | | |
| (ASTM D217) | | | | | |
| 90° Peel strength | 6.8 | 6.6 | 6.6 | 9.3 | >6 |
| @77° F., pli | *CF | CF | CF | CF | CF |
| (ASTM D903-98 | | | | | |
| modified) | | | | | |
| Tensile adhesive | 23 | 20 | >20 | >20 | >20 |
| strength @77° F., psi | CF | CF | CF | CF | CF |
| (ASTM C907) | | | | | |
| Sag (AAMA 807.3-92) | Pass | Pass | Pass | Pass | Fail |
| Vehicle Bleedout | Pass | Pass | Pass | Pass | — |
| (ASTM C772) | | | | | |
| Resistance to | Excellent | Excellent | Excellent | Excellent | Excellent |
| fungus/mildew | | | | | |
| growth | | | | | |
| Flexibility (ASTM | Good | Good | Good | Good | Good |
| C765) | | | | | |

*CF = Cohesive Failure

In Table 3, example 5-8 illustrates that talc, used alone or in combination with precipitated silica, improves the sag resistance. In example 9, the formulated material fails on sag resistance when reinforcement fillers are absent.

TABLE 4

| | Examples | | |
|---|---|---|---|
| | 10 | 11 | 12 |
| Sub-components | % by weight | | |
| Kalar 5280 | 4.60 | — | — |
| XL 10000 | — | 4.60 | — |
| Exxpro 3433 | — | — | 4.60 |
| Antioxidant | 0.13 | 0.13 | 0.13 |
| Biocide | 0.03 | 0.03 | 0.03 |
| Piccopale 100 | 1.40 | 1.40 | 1.40 |
| Butex | 0.05 | 0.05 | 0.05 |
| Polybutene | 21.00 | 21.00 | 21.00 |
| Calcium carbonate | 70.69 | 70.69 | 70.55 |
| Precipitated silica | 2.10 | 2.10 | 2.10 |
| Amine curative | — | — | 0.13 |
| Specific gravity | 1.74 | 1.74 | 1.74 |
| Initial cone penetration | 172 | 149 | 129 |
| (ASTM D217) | | | |
| 90° strength @77° F., pli | <4 | <4 | >6 |
| (ASTM D903-98 modified) | *CF | CF | CF |
| Tensile adhesive strength @77° F., psi | <15 | <15 | >20 |
| (ASTM C907) | CF | CF | CF |
| Sag (AAMA 807.3-92) | Fail | Fail | Pass |
| Vehicle Bleedout (ASTM C772) | — | — | — |
| Resistance to fungus/mildew growth | — | — | Excellent |
| Flexibility (ASTM C765) | Good | Good | Good |

*CF = Cohesive Failure

In Table 4, these examples show that compounds formulated with commercially available pre-crosslinked butyl rubbers such as Kalar (Elementis Performance Polymers) and XL-10000 (Bayer Corporation) exhibit inferior properties in sag resistance, peel strength, and tensile adhesive strength in comparison to compound formulated with Exxpro rubber crosslinked with amine curative.

Based on test results presented in Table 2, 3 and 4, embodiments of the invention may comprise those with characteristics falling within specification ranges set out in Table 5.

TABLE 5

| Properties | Test Method | Range/Result |
|---|---|---|
| Specific gravity | ASTM D792 | 1.60-1.80 |
| Weight per gallon | ASTM D1475 | 13.0-15.0 lbs./gal |
| Cone Penetration | ASTM D217, 300 grams | 70-110 |
| | total weight, 1/10 mm at | |
| | 77° F. | |
| 90° Peel Strength | ASTM D903-98 Modified | 6-10 pounds per linear inch (pli) |
| | | with masking tape backing, |
| | | substrate: acrylic liner; tape |
| | | thickness: 2 mm |
| Adhesive Tensile | ASTM C907, metal to metal | 20-30 pound per square inch |
| Strength | at 77° F. | (psi). Mode of failure: cohesive |
| Sag | AAMA 807.3-92 | Pass |
| Vehicle Bleedout | ASTM C772 | No exudation of vehicle on |
| | | Whatman No. 40 filter paper |
| | | after exposure to 158° F. (70° C.) |
| | | for 21 days |
| Resistance to fungus/ | At 77° F. | Excellent |
| Mildew growth | | |
| Flexibility | ASTM C765 | No cracking or loss of adhesion |
| | | at −40° F. (−15° C.) when bent |
| | | around 3/8 inch mandrel |

While the present invention has been particularly shown and described with reference to the foregoing preferred and alternative embodiments, it is to be understood that this is by way of illustration and not of limitation, and various alternatives to the embodiments of the invention described herein may be employed in practicing the invention without departing from the spirit and scope of the invention as defined in the following claims, which should be construed as broadly as the prior art will permit.

1. A cured adhesive composition for adhering bath linings comprising:
a halogenated copolymer of isobutylene and paramethylstyrene,
a tackifier,
one or more fillers,
one or more reinforcing fillers, and
an amine curative agent.

2. The cured adhesive composition of claim 1, wherein the tackifier is comprised of polybutene.

3. The cured adhesive composition of claim 1, further comprising an antioxidant.

4. The cured adhesive composition of claim 1, further comprising an antimicrobial additive.

5. A cured adhesive composition for adhering bath linings comprising:
4-8 wt % of a halogenated copolymer of isobutylene and paramethylstyrene,
15-25 wt % of tackifier,
one or more fillers,
one or more reinforcing fillers and
0.01-0.1 wt % of an amine curative agent.

6. The cured adhesive composition of claim 5, wherein the composition comprises, as one or more fillers and reinforcing fillers, 60-80 wt % of calcium carbonate and 1-5 wt % of precipitated silica.

7. The cured adhesive composition of claim 5, wherein the tackifier is comprised of polybutene.

8. The cured composition of claim 5, further comprising 0.05-0.5 wt % of an antioxidant.

9. A cured adhesive composition for adhering bath linings comprising:
4-8 wt % of a halogenated copolymer of isobutylene and paramethylstyrene,
15-25 wt % of polybutene,
60-80 wt % of calcium carbonate,
1-5 wt % of precipitated silica,
0.01-0.1 wt % of an amine curative agent, and
0.05-0.5 wt % of an antioxidant.

10. The cured adhesive composition of claim 9, further comprising an antimicrobial additive.

11. An adhesive tape for adhering bath linings comprising a layer of a cured adhesive composition in the form of a strip on a release liner, said adhesive composition comprising:
a halogenated copolymer of isobutylene and paramethylstyrene,
a tackifier,
one or more fillers,
one or more reinforcing fillers, and
an amine curative agent.

12. The adhesive tape of claim 11, wherein the tackifier is compromised of polybutene.

13. The adhesive tape of claim 11, further comprising an antioxidant.

14. The adhesive tape of claim 11, further comprising an antimicrobial additive.

15. An adhesive tape for adhering bath linings comprising a layer of a cured adhesive composition in the form of a strip on a release liner, said adhesive composition comprising:
4-8 wt % of a halogenated copolymer of isobutylene and paramethylstyrene,
15-25 wt % of tackifier,
one or more fillers,
one or more reinforcing fillers, and
0.01-0.1 wt % of an amine curative agent.

16. The adhesive tape of claim 15, wherein the composition comprises, as one or more fillers, 60-80 wt % of calcium carbonate and 1-5 wt % of precipitated silica.

17. The adhesive tape of claim 15, wherein the tackifier is comprised of polybutene.

18. The adhesive tape of claim 15, wherein the cured adhesive composition is further comprised of 0.05-0.5 wt % of an antioxidant.

19. An adhesive tape for adhering bath linings comprising a layer of a cured adhesive composition in the form of a strip on a release liner, said adhesive composition comprising:
4-8 wt % of a halogenated copolymer of isobutylene and paramethylstyrene,
15-25 wt % of polybutene,
60-80 wt % of calcium carbonate,
1-5 wt % of precipitated silica,
0.01-0.1 wt % of an amine curative agent, and
0.05-0.5 wt % of an antioxidant.

20. The adhesive tape of claim 19, further comprising an antimicrobial additive.
